(19) United States
(12) Patent Application Publication
(10) Pub. No.: US 2005/0010319 A1
(43) Pub. Date: Jan. 13, 2005

(54) System and method for validating and visualizing APC assisted semiconductor manufacturing processes

(76) Inventors: Sukesh Patel, Sunnyvale, CA (US); Raj Raheja, Pound Ridge, NY (US)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 10/617,919

(22) Filed: Jul. 9, 2003

(51) Int. Cl. G06F 19/00

(52) U.S. Cl. 700/121; 700/29

(57) ABSTRACT

A system and/or methodology that facilitates verifying and/or validating an APC assisted process via simulation is provided. The system comprises a film stack representation and a canonical model. The canonical model can predict process rates based at least in part upon an exposed material in the film stack representation. A solver component can also be provided to generate an updated recipe set-point according inputs and outputs of the canonical model.

### TECHNICAL FIELD

The present invention relates generally to semiconductor fabrication, and more particularly to validating and/or visualizing Advanced Process Control (APC) assisted semiconductor manufacturing processes.

### BACKGROUND OF THE INVENTION

As dimensions of semiconductor devices decrease, available process window size decreases and manufacturing design rules shrink requiring tighter control over a manufacturing process. Generally, improvements in semiconductor fabrication processes and/or improvements in structural fabrication are required in order to further decrease critical dimensions and, thereby semiconductor devices. However, tighter control over the manufacturing process can be difficult to achieve, especially as critical dimensions decrease further.

Semiconductor fabrication is a manufacturing process employed to create semiconductor devices in and on a wafer surface. Polished, blank wafers come into semiconductor fabrication, and exit with the surface covered with large numbers of semiconductor devices. The semiconductor fabrication includes a large number of steps and/or processes that control and build the devices. The basic processes utilized are layering, patterning, doping, and heat treatments. Layering is an operation that adds thin layers to the wafer surface. Layers can be, for example, insulators, semiconductors and/or conductors and are grown or deposited via a variety of processes. Some common deposition techniques are chemical vapor deposition (CVD), evaporation and sputtering. Patterning is a series of steps that results in the removal of selected portions of surface layers. After removal, a pattern of the layer is left on the wafer surface. The material removed can be, for example, in the form of a hole in the layer or a remaining island of the material. The patterning transfer process is also referred to as photomasking, masking, photolithography or microlithography. Actual subtractive patterning, e.g removal of material from a surface film, is done by plasma etching. A goal of the patterning process is to create desired shapes in desired dimensions (e.g., feature size) as required by a circuit design and to locate them in their proper location on the wafer surface. Patterning is generally considered the most important of the four basis processes. Doping is the process that adds specific amounts of dopants to the wafer surface. The dopants can cause the properties of layers to be modified (e.g., change a semiconductor to a conductor). A number of techniques, such as thermal diffusion and ion implantation can be employed for doping. Heat treatments are another basis operation in which a wafer is heated and cooled to achieve specific results. Typically, in heat treatment operations, no additional material is added or removed from the wafer, although contaminates and vapors may evaporate from the wafer. One common heat treatment is called annealing, which repairs damage to crystal structure of a wafer/device generally caused by doping operations. Other heat treatments, such as alloying and driving of solvents, are also employed in semiconductor fabrication.

A semi-conductor manufacturing process is associated with a plurality of process steps. A typical step subjects material on a surface of a wafer to a chemical process in a process tool chamber. For example, a poly-gate etch process step subjects exposed photo-resist material of a film stack to ion bombardment via a chemical process, wherein the film stack can include a plurality of substrates atop one another, such as BARC, Nitride Oxide, etc. The chemical process is characterized and controlled via a process recipe that defines settings for process control parameters, such as RF Power, gas flows, pressure, time duration, etc. Values of process control parameters establish necessary operating conditions for a process step. A recipe applied to a process tool for a particular process step can be characterized as an assignment of values for process control parameters (e.g., O₂ flow of 25 sccm, RF Power of 1200 watts, . . .). The recipe can be centered via determining values for process parameters that are optimal given the particular process step, wherein optimal process parameter values result in best output results for a plurality of sequential wafers given natural variation in materials (wafers) and fluctuations in process tool operating conditions.

Processes utilized in semiconductor fabrication typically employ a significant number of variables. A process can, for example, employ one or more flow rates, composition ratios, temperature, pressure, spin rate, time, etc. Additionally, these variables are generally subject to processing constraints that facilitate reduction or prevention of damage to the wafer and/or semiconductor device. Constraints can also be employed to ensure creation and/or maintenance of desirable device characteristics (e.g., fast switch speeds, low leakage current, . . .). Requiring oxygen to be greater than 15 sccm and less than 20 sccm or that a CHF₃/CF₄ ratio not to exceed 20 are two exemplary constraints. Due to number of variables involved, constraints on those variables, and desire to create favorable device characteristics while suppressing undesirable device characteristics, it can be difficult to control a manufacturing process let alone maximize benefits of the manufacturing process. It has been empirically observed that controlling the manufacturing process becomes even more challenging as smaller and smaller devices need to be fabricated.

Control of fabrication processes can be improved via feed forward and feedback control techniques that use in situ (or in-line) data to improve the results of the process. These techniques are known as Advanced Process Control (APC) techniques and typically work by building a predictive model of the manufacturing fabrication process. The predictive model being ordinarily mathematically described as a function of material film stack, process chemistry, and physical characteristics of a device being manufactured. The predictive model can “predict” an outcome (e.g., values for one or more device characteristics) of a manufacturing process given a state of the predictive model via utilizing a value for a desired outcome and thereafter “solving” the predictive model to identify a required state of process variables. Process tool recipes can be altered at runtime based upon one or more variable inputs to the predictive model.

Predictive models can be generated and verified without substantial difficulty in occurrences that the models comprise a small number of variables, as the variable process models can typically be quickly solved as linear or quadratic problems. Furthermore, the predictive models can be quickly verified on a trial-and-error basis via altering the variables on actual and/or test wafers. However, more complex predictive models that utilize a higher number of variables are more difficult to solve, and are often nonlinear, thus further increasing difficulty in solving the predictive models. Moreover, validation of a generated complex process model can become expensive and inefficient, as conventional systems and/or methods of validating predictive models require empirical results from a test wafer and/or processed wafers. For example, in an instance an operator desires testing of a particular process step, the operator can force variation in the process step input via adjusting process parameters of previous step(s), and thereafter perform the particular test step with process tool settings recommended by the predictive model. Upon completion of the test process step, output characteristics of interest are measured and recorded, and the predictive model is adjusted accordingly. Such conventional validation of a predictive model is expensive and inefficient, as the testing consumes test wafers and/or actual wafers, tool time, operator time, etc. Moreover, after incurring testing expenses the predictive model can remain faulty, as expenses increase with a number of process variables modified. For at least the above reasons, a more efficient system and/or method for validating predictive models of a semi-conductor manufacturing process is desirable.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention facilitates simulation of a semiconductor manufacturing process thereby enabling operator verification and/or validation of an APC assisted system, and overcomes many of the aforementioned deficiencies related to conventional systems and or methods of verifying and/or validating such APC assisted process. The present invention employs a canonical model to predict process rates given a material and current state of a process chamber. For example, given a particular material of specific size as well as process chamber parameters such as RF-power, O₂ flow, elapsed time, etc. the canonical model can predict physical effects on the material over time. The canonical model can be created via generating and expanding a training set based upon outputs of an APC assisted system given known inputs and settings. Thereafter, a predictive model that can predict process rates can be created based at least in part upon the expanded training set.

A film stack representation is provided to illustrate a plurality of layers and blocks of materials. For instance, a film stack can include a plurality of disparate layers, and the layers can be defined by a plurality of blocks. The blocks themselves can be user and/or automatically defined via material type and size (e.g., height, width, and/or length). Such film stack representation can be utilized to determine a material subject to chemical processing within a process chamber (e.g., an exposed material). Moreover, the film stack representation can be displayed graphically, wherein during simulation of a semiconductor manufacturing process the graphical representation of the film stack varies according to the simulated process (e.g., the film stack representation can graphically illustrate material being removed during simulation in real-time or otherwise).

Parameters regarding a process chamber are captured at pre-defined time intervals, thereby creating process chamber state(s) at particular times, and relayed to the canonical model. Such parameters can include but are not limited to a current material exposed on the film stack representation, various physical properties of the device (e.g., material size), material flow in the process chamber, power delivered to the chamber, etc. As real-world inputs are subject to variation due to mechanical imperfection or otherwise, the present invention employs tools that can vary process inputs according to user-defined and/or empirically determined distribution corresponding to an input. For example, an operator can desire a semiconductor material to be 100 nm in length and 200 nm in height. However, due to mechanical and/or control imperfections, after such material is sized actual dimensions can be 99.7 nm in length and 201.2 nm in height. Moreover, control devices within a process, such as flow controllers and voltage regulators, are subject to inherent variation. Therefore pseudorandom generators (e.g., Multiplicative Linear Congruential Generators) are utilized to provide simulated chamber parameters according to a particular recipe set-point and parameter distribution.

The process chamber states are received by the canonical model, and process rates are predicted based at least in part upon parameters of chamber states. For instance, as elapsed time between chamber states is a parameter within a chamber state, a processing rate can be predicted by the mathematical model between two states. The film stack representation is updated according to the exposed material and the predicted process rate over a desirable simulation time (e.g., an operator can determine simulation speed, starting and/or stopping positions within a simulation, . . .). A control mechanism (e.g., solver) can be provided to determine appropriate commands to process tools (e.g., flow controllers, voltage regulators, . . .) to obtain a desirable process rate for an exposed material in the film stack representation, and thereafter adjust a recipe set-point according to predicted results. Recipe set-points are associated with inputs that can facilitate generation of desirable outputs at a particular point in time. For example, an etch process can have a desirable output rate of 0.02 nm/sec in a vertical direction and 0.04 nm/sec in a horizontal direction. Such rates require particular actions of process chamber tools (thereby requiring particular control values), wherein such tools (and thus control values) are subject to variation. The solver determines control values based upon other various inputs, constants, and settings, and such values are thereafter included in a recipe set-point.

A graphical user interface (GUI) is provided to enable an operator to review performance of the control mechanism (solver) prior to implementing such solver in an actual manufacturing process. The operator can analyze data before, during, and/or after simulation as simulation can be desirably halted at any point in time. Moreover, the GUI permits the operator to provide specifications for process inputs, film stack composition and dimensions, and distribution parameters for process inputs and control devices, therefore lending the subject invention customizable for disparate processes, materials, and tools. Furthermore, the present invention enables validation of a semiconductor manufacturing process, wherein validation refers to ensuring that an APC assisted process meets output specifications over an allowable input specification. For example, the film stack representation subject to a process can be visualized at a block level, which facilitates predicting local effects such as gate profile, notches, undercuts, etc.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a block diagram of a system that simulates a semiconductor manufacturing process in accordance with an aspect of the present invention.

FIG. 2 is a block diagram of a canonical model that can be employed in connection with the present invention.

FIG. 3 is a block diagram of a system that simulates a semiconductor manufacturing process in accordance with an aspect of the present invention.

FIG. 4 is a representative flow diagram illustrating simulation of a semiconductor manufacturing process in accordance with an aspect of the present invention.

FIG. 5 is a representative flow diagram illustrating simulation of a semiconductor manufacturing process in accordance with an aspect of the present invention.

FIG. 6 is an exemplary graphical user interface in accordance with an aspect of the present invention.

FIG. 7 is an exemplary graphical user interface in accordance with an aspect of the present invention.

FIG. 8 is an exemplary graphical user interface in accordance with an aspect of the present invention.

FIG. 9 is an exemplary system that facilitates in situ monitoring in accordance with an aspect of the present invention.

FIG. 10 illustrates an example operating environment in which the present invention may function.

FIG. 11 is a schematic block diagram of a sample-computing environment with which the present invention can interact.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “computer component” is intended to refer to a computer-related entity, either hardware, a combination of hardware and software, software, or software in execution. For example, a computer component may be, but is not limited to being, a process running on a processor, a processor, an object, an executable, a thread of execution, a program, and/or a computer. By way of illustration, both an application running on a server and the server can be a computer component. One or more computer components may reside within a process and/or thread of execution and a component may be localized on one computer and/or distributed between two or more computers.

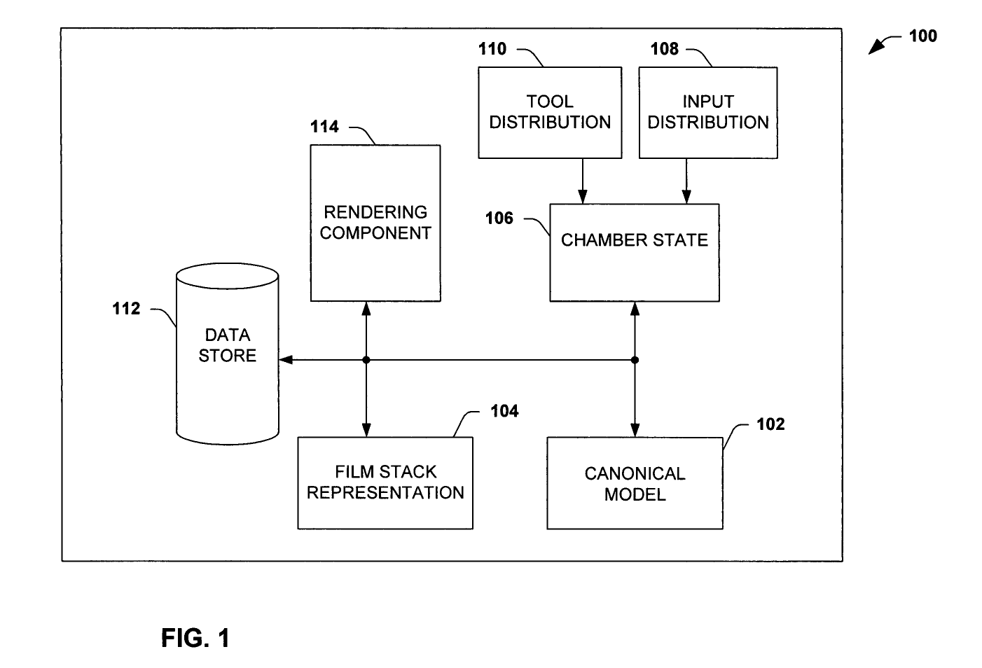

Referring now to the drawings, FIG. 1 illustrates a high-level system overview in connection with one particular aspect of the subject invention. The present invention relates to a novel system 100 for verifying and validating an Advanced Process Control (APC) assisted model via simulating a manufacturing process without utilizing actual and/or test wafers, thereby mitigating aforementioned deficiencies of conventional verifying and validating techniques. The system 100 facilitates verifying and/or validating a recipe for a particular process tool given desirable outputs. For example, an APC solver engine can calculate a recipe given desirable outputs, and thereafter the system 100 can simulate the impact of such recipe within a semiconductor manufacturing process without utilizing actual and/or test wafers to obtain empirical data. The system 100 comprises a canonical model 102 that can include predictive model(s) typically employed by APC systems. A predictive model comprised by the canonical model 102 is an abstraction and/or simulation of actual processing parameters and conditions and predicts outputs based on settings and inputs. Predictive models generally include a mathematical description of a semiconductor device and one or more fabrication processes. The description typically includes a vector of outputs, a vector of inputs, and a vector of desired settings. The model outputs are essentially predictions based upon the inputs and settings. Inputs typically affect processing conditions, such as etch rates (e.g., isotropic and/or anisotropic), doping concentrations, layer thickness and other similar processing conditions. Outputs can include anisotropic etch rate, post-etch microloading, etc. Variables such as oxygen flow, pressure, power bias, oxide thickness, and photo-resist line width can selectively be inputs, outputs, and/or settings. The aforementioned variables are exemplary and not meant to be exhaustive, as all suitable inputs, outputs, and settings within a semiconductor manufacturing process are contemplated by the present invention.

Constraints express mathematical relationships among the predictive model inputs, outputs, and/or settings. In many cases constraints express limits or conditions placed on the predictive model inputs, outputs, and/or settings. Typically, constraints can be empirically obtained from previous semiconductor manufacturing process(es) (e.g., experience), and facilitate reducing damage to devices being fabricated as well as improvements in terms of performance, quality, etc.. Constraints can place limits on the desired operation of a process tool. For example, a typical model constraint can require oxygen flow to be greater than 10 sccm and less than 20 sccm, or require a ratio of CHF₃/CF₄ to be maintained below the etch bias divided by 10. Model goals on the other hand capture some desirable outcome or target of a semiconductor manufacturing process. Requesting an output gate line width be 100 nm with a maximum variation of +/−2 nm is an exemplary model goal. Given particular model constraints and a goal function, as well as a vector of outputs corresponding to vectors of inputs and settings, a predictive model that can predict process rates for particular materials and process steps can be generated. The canonical model 102 can comprise a plurality of such predictive models corresponding to a variety of process steps and materials employed in such process steps. Therefore, given a particular material, inputs, settings, process step, and constraints, the canonical model 102 can return predicted rates of addition and/or removal of material during the process step.

The system 100 further comprises a film stack representation 104 that can describe physical characteristics of a film stack subject to particular process steps. In a simulation environment, the canonical model 102 can simulate a process step at a defined processing rate given a vector of inputs, settings, constraints, and goal function(s). For example, if BARC material is exposed on the film stack representation 104, the canonical model 102 will utilize a predictive model to simulate a semiconductor manufacturing process relating to the impact of the processing step on the BARC layer. The film stack representation 104 can be updated according to process rates predicted by the canonical model 102. For instance, height, length, and width of a material can be updated within the film stack representation 104 based in part upon process rates predicted by the canonical model 102. Moreover, multiple process steps can be simulated, as the present invention enables simulation of processes for each material associated with the film stack representation 104. Multiple-process step simulation enables a process engineer to visualize individual as well as collective process step impacts, thereby effectuating robust verification and/or validation of an APC assisted system.

The film stack representation 104 can be in 2-dimensions or 3-dimensions, and can be created graphically or textually. For example, fields enabling insertion of parameters relating to material type, height, width, and length can be provided. Alternatively, an operator can graphically select a material from a materials library and place such material on a film stack, wherein the height, width, and length of the material can be manipulated via a click-and-drag method, keystrokes, etc. In accordance with one aspect of the present invention, the film stack representation 104 comprises a plurality of layers of materials, and the layers comprise a plurality of blocks. A block can be defined by particular material of specific dimensions. For example, the film stack representation can comprise six layers, and a particular layer can comprise four blocks. The blocks can be defined by material type and size (e.g., either two or three dimensions). Therefore, the particular layer can comprise of two blocks (Block 1) of BARC of substantially similar dimensions, one block (Block 2) of Nitride of specific dimensions, and one block (Block 3) of photo-resist of particular dimensions. Thus, the particular layer can be categorized as <Block 1;Block 1;Block 2;Block 3>. Moreover, a block representing absence of material can be utilized to effectively represent actual film stacks. Utilizing blocks as an elementary component of the film stack representation 104 facilitates simulating localized phenomenon such as undercutting, notches, profiles, etc. Note that blocks can be made arbitrarily small to allow for the simulation of local effects.

In accordance with another aspect of the present invention, the film stack representation 104 can include guarded predictive models. Guarded models permit the association of an ordered set of predictive models with a single physical unit of material (e.g., block or layer.) Guards are Boolean valued functions that evaluate to true or false based on a current processing state (e.g., a function of inputs, outputs, settings, current film stack representation . . .). The predictive model associated with a first true guard is used to compute processing rates. Guarded models allow different predictive models to be used during course of a simulation for a same physical unit. Thus for example, the simulation can utilize a particular predictive model for a layer of BARC when such layer is completely covered by photo-resist but use a disparate predictive model when the photo-resist is completely removed thus exposing the BARC to the full force of the process chemistry.

Current conditions of a chamber in which a process step is being simulated can be captured via a chamber state component 106 and received by the canonical model 102. Such a chamber state component 106 facilitates optimal simulation of a manufacturing process, as conditions within a process chamber typically vary over time. Moreover, the chamber state component 106 utilizes the film stack representation 104 and process rates predicted by the canonical model 102 to generate an appropriate chamber state. For example, a chamber state generated by the chamber component 106 can include a flow rate of O₂, amount of HBr within a chamber, RF-power utilized by a process step within the chamber, elapsed-time of simulation, simulation start time, exposed layer identity, etch rate, etc.

The state component 106 can be associated with an input distribution component 108 and a tool distribution component 110. Typically, inputs to the canonical model 102 are subject to variation. For example, an actual height and width of a material can be 101.2 nanometers and 200.78 nanometers, respectively, while a desirable height is 100 nanometers and a desirable width is 200 nanometers (e.g., a machine cutting a layer of material is subject to a particular distribution regarding height and width). Distributions are characterized by distribution type (e.g., normal, binominal, Poisson, . . .), mean, and standard deviation. Typical distribution can be described by a mean μ and standard deviation σ. In accordance with one aspect of the present invention, an operator can specify distribution for each process input subject to variation. Multiplicative Linear Congruential Generators (MLPCGs) and other suitable pseudorandom variate generators can be employed to produce samples for utilization in simulation. The samples can be generated based on a distribution of a particular input. A data store 112 can retain distributions for corresponding inputs. The data store 112 can further facilitate storing predicted results from the canonical model 102, corresponding states from the chamber state 106, and particular film stack representations 104.

In accordance with another aspect of the present invention, the input distribution component 108 can generate a tuple of values that can be associated with a chamber state regarding a particular process. For example, photo resist height and width can be inputs for a particular process step. The input distribution component 108 can generate a tuple such as <101.2, 200.78>, wherein 101.2 and 200.78 are a compatible height and width, respectively. Therefore, the input tuple accurately models incoming input values. Furthermore, the tool distribution component 110 can facilitate generating sample data regarding devices that govern conditions within a process chamber, such as mass flow controllers, voltage regulators, etc. Such devices have inherent variability, and often are associated with well-characterized distributions. Alternatively, a distribution of a device can be generated via DOE execution. Sensor data can be collected for each device controller through utilization of SECS/GEM, HSMS, or other suitable data input technique. For example, in an instance distribution data regarding CF₄ is desired, a gas flow sensor for CF₄ can be employed during performance of a DOE. Upon completion of the DOE a plurality of control devices will have associated data, which can be organized to produce a distribution for particular control devices via known statistical techniques.

An exemplary chamber state generated by the chamber state component 106 is illustrated below.

TABLE 1
State

| Number | Name | Type | Value |
|---|---|---|---|
| 1 | O₂-flow | sccm | 30 |
| 2 | HBr | sccm | 70 |
| 3 | RF-Power | Watts | 2000 |
| 4 | Elapsed-Time | Sec | 65 |
| 5 | Start-time | Time | Apr. 12, 2003, |
| | | | 20:45:56 |
| 6 | Exposed-layer | String | Layer[2] |
| 7 | DI | Nm | 120 |
| 8 | FI-target | Nm | 100 |

O₂ flow, HBr, and RF-Power can be generated by the tool distribution component 110, DI can be generated by the input distribution component 108, and the exposed layer can be determined from the film stack representation 104. It is to be understood that the exemplary chamber state of table 1 can include a plurality of other variables, and values within the table are not to limit scope of the invention in any manner.

The chamber state can be received by the canonical model 102, which comprises process rates that affect the chamber state and the film stack representation 104. Interaction of the canonical model 102, the film stack representation 104, and the chamber state component 106 facilitates robust simulation of a semiconductor manufacturing process. In accordance with an aspect of the present invention, a chemical process step is represented as a time ordered sequence of chamber states (e.g., simulation data, process input data, chamber condition data, . . .). Chamber states in the time ordered sequence for a particular process step can include a substantially similar input tuple from the input distribution component 108, but disparate variables generated by the tool distribution component 110. Such generated values are thereafter concatenated with other constants and simulation parameters relating to semiconductor manufacturing and packaged into a state. The state further includes an exposed layer from the film stack representation 104. The canonical model 102 receives the state and an appropriate predictive model is selected. Process guards within the film stack representation 104 are evaluated, and the process step is simulated according to such guards. Values in the state are utilized to determine displacement of exposed material in each direction based upon the process rate of the canonical model 102 and elapsed time. As new states are generated and processed, the simulation enables an operator to visualize impact of the simulated process step on dimensions of the material being processed via a rendering component 114.

The states, calculations of the canonical model 102, and corresponding film stack representation 104 can be received by the data store 112 and the rendering component 114, thereby facilitating storage and/or display of a simulation. The rendering component can display the film stack representation 104 as a process step is simulated. An operator can select speed of simulation, thereby enabling visualization of a process at a desirable rate. Enabling operator-selection of simulation time facilitates efficient verification and/or validation of predictive models, as an operator can quickly simulate a semiconductor manufacturing process until a desirable process step is reached, and thereafter slow the simulation to enable verification and/or validation at a particular point. The rendering component 114 can graphically render such state information and corresponding film stack representation 104. Furthermore, the rendering component 114 can be utilized to display simulation data textually and/or in two or three dimensions, relay rendered information to a printer, PDA screen, wireless device, etc.

The rendering component 114 can be associated with a graphical user interface (GUI) (not shown) that provides capabilities for analyzing predicted performance of an APC assisted process, validating process performance, and in situ process monitoring. For example, metrology tools can supply input data in lieu of the input distribution component 108, and sensors that measure actual conditions within the chamber can be used in lieu of the tool distribution component 110. The chamber state constructed with metrology inputs and tool sensor data is utilized with the film stack representation 104 and enable in situ monitoring.

An operator can provide specifications for process inputs, film stack composition and dimensions, control settings, distribution parameters for process inputs and control devices, etc. Enabling the operator to alter the aforementioned parameters regarding an APC assisted system effectuates visualization of impact of inputs and setting variations on process output. The operator can thus explore and analyze a complete process window of an APC assisted process.

Furthermore, an operator can validate that an APC assisted process meets output specifications over an input specification via employing the subject invention. The operator can supply the system 100 with a minimum incremental step for a plurality of process inputs. Process inputs within the specification range can be systematically generated and submitted to a solver component (not shown) that generates recommended settings that are utilized as seeds to the tool distribution component 110. The tool distribution component 110 can thereafter generate inputs based upon the recommended settings within a defined distribution. Such inputs and settings are received by the canonical model 102 within a chamber state to facilitate simulation of a semiconductor manufacturing process. The rendering component 114 can facilitate display of such simulation to the operator, and the operator can review outputs of interest, such as target output values, output specification violations, control setting range violation, etc.

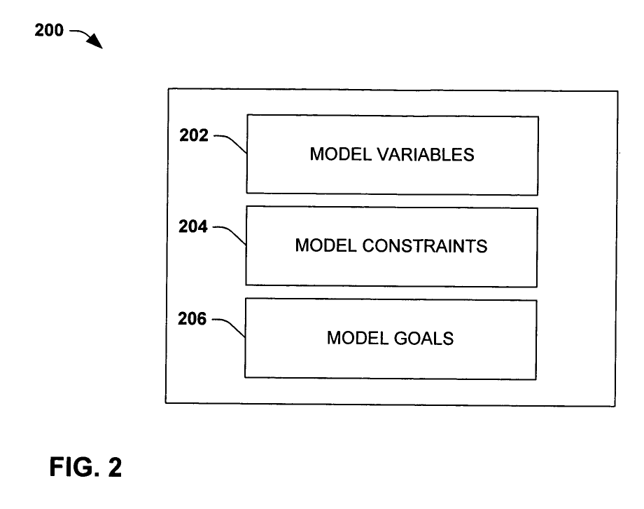

Turning now to FIG. 2, a high-level overview of a canonical model 200 that can be employed in connection with the present invention is illustrated. The canonical model 200 includes model variables 202, which include vectors of inputs, outputs, and settings. Moreover, the canonical model comprises model constraint(s) 204 and goal function(s) 206. The vectors of inputs, outputs, and settings 202 along with the corresponding constraints 204 and goal functions 206 can be utilized to create a predictive model that can predict process rates of a particular material within a specific process step. Mathematically, a predictive model associated with the canonical model 200 can be characterized via the following equations:
O≡vector of outputs;
I≡vector of inputs;
S≡vector of settings; and
T₀≡a training set; where the vector of settings can be inputs selected according to a particular predictive model, and the training set is determined from a design of experiments (DOE), wherein O is observed with particular inputs I and settings S. The training set T₀ can be utilized to generate an initial predictive model F₀, wherein F₀ is a vector of functions predicting a particular output O based upon values of I and S. Therefore,

P₀=F₀(I,S)=predicted values of O₀.

As the model F₀ is applied, a new data point is obtained and added to the training set T₀, thereby creating an enhanced training set T₁. The enhanced training set T₁ is utilized to generate an enhanced model F₁, and thereafter such process is iterated to generate predictive models Fᵢ. Furthermore, a goal function G(P) can be minimized (or maximized) via applying predictive model Fᵢ for inputs I and S. Constraints (such as the aforementioned constraints) can likewise be implemented in the model, and can be of a form
Cᵢ(P)<=cᵢ; Cᵢ(P)=cᵢ; Cᵢ(P)>cᵢ;
and similar constraint functions, wherein cᵢ represents a constant. Thereafter, the canonical model 200 is utilized to express APC systems in terms of desirably simulated manufacturing process outputs, such as etch rates, deposition, CMP, etc. For example, the canonical model 200 can include a predictive model that predicts material removed in a horizontal direction for a given layer of material, wherein the predictive model is expressed as a function of etch control parameters. An exemplary equation predicting material removed in the horizontal direction can be as follows:

$$displacement = \frac{0.005 \times ( {CHF}_{3} - 100 )}{50} + .2 {CF}_{4} = Δ x ;$$

where displacement is defined as the amount of material removed (for etch). In the above exemplary equation, displacement represents the amount of material etched in a horizontal direction (Δχ) over duration of a process step. Δχ can be employed to characterize horizontal displacement over time t, thereby rendering the exemplary equation as follows:

$$\frac{Δ x}{t} = {e}_{x} = ( \frac{0.005 ( {CHF}_{3} - 100 )}{50} + 0.2 {CF}_{4} ) / t nm \text{/} sec$$

where eₓis etch rate in a horizontal direction for a particular material (e.g., BARC). Etch rates for other dimensions (e.g., e_{y}, e_{z}, . . .) can be modeled via a similar technique. Process rate models, such as the exemplary etch rate, can be utilized to define height, width, and length of a material during and/or after a manufacturing process (e.g., etch). Moreover, if process rates are non-uniform over a surface of a wafer, a vector of process rates becomes desirable—one vector for each dimension of non-uniformity. The canonical model 200 can thus be utilized to facilitate determining process rate(s) over a surface of a particular material.

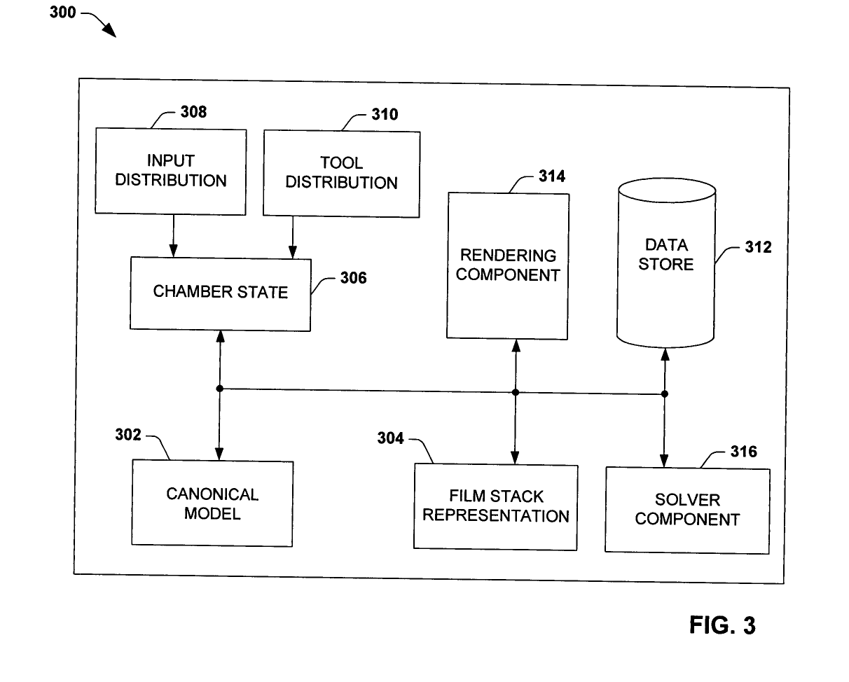

Turning now to FIG. 3, a system 300 that facilitates simulation of a semiconductor manufacturing process is illustrated. The system 300 comprises a canonical model 302 that includes one or more predictive models for determining process rate(s) for disparate material(s). The canonical model 302 can further contemplate constraint(s) as well as goal function(s) to determine effects of a process on a particular material. Thus the canonical model 302 can describe impact of a semiconductor manufacturing process on material(s) as a function of inputs and settings. For example, given a particular material with a specific height and width, the canonical model 302 can be utilized to define the impact of the processing step on the height and width of the material during and/or after processing.

A film stack representation 304 can be provided to describe physical characteristics of a film stack that will be subject to particular process step(s). The film stack representation 304 can be constructed in a graphical user interface (not shown) utilizing click-and-drag methodologies, keystrokes, touch screens, etc. Layers are utilized to describe the film stack representation 304, and blocks are employed to describe the layers. Utilizing blocks as elementary components of the film stack representation 304 facilitates simulation of localized phenomenon like undercutting, notches, profiles, etc. Moreover, the film stack representation 304 can be updated over time based on the process rates predicted by the canonical model 302 and other various parameters.

The system 300 further comprises a chamber state component 306 that facilitates representation and generation of simulated chamber states (or “actual” states for insitu monitoring). The chamber state component can be associated with an input distribution component 308 and a tool distribution component 310. The input distribution component 308 can generate input variables, such as material parameters (e.g., height, width, length, . . .), according to a distribution associated with such variables. In accordance with one aspect of the present invention, the distribution can be entered via a GUI (not shown). Such distribution can be previously known or determined through a DOE. The tool distribution component 310 facilitates generating sample data regarding devices that govern conditions within a process chamber, such as mass flow controllers, voltage regulators, etc. Such devices have inherent variability, and often are associated with well-characterized distributions. Alternatively, a distribution of a device can be generated via DOE execution.

The chamber state component 306 can generate chamber states according to constants, variables generated by the input distribution component 308, variables generated by the tool distribution component 310, and an exposed material in the film stack representation 304. A simulation time interval can be selected, thereby causing chamber states to be generated at particular time intervals. The canonical model 302 receives chamber states and simulates a semiconductor manufacturing process over time via predictive model(s) associated with current chamber states. The chamber states continue to vary as the canonical model 302 applies process rates to an exposed material in the film stack representation 304 and the tool distribution component 310 continues to generate input variables. A data store 312 can retain a simulation of a semiconductor manufacturing process and/or process step, as well as corresponding chamber states and film stack representation(s) 304. A rendering component 314 facilitates display of the simulation to an operator.

The system 300 can further comprise a solver component 316 that identifies recommended control settings (e.g., inputs) given a particular predictive model and desired process outputs. The solver component 316 can generate a solution (e.g., appropriate input values to the canonical model 302) given a predictive model and a recipe set-point for a desired semiconductor manufacturing process. For example, given values for particular input variables (e.g., an input tuple), a set of optimal control parameter settings (e.g., recipe parameters) can be calculated. Such optimal control parameter settings can later be utilized by a control system that controls a semiconductor manufacturing process. An exemplary solver engine that can be utilized as the solver component 316 in connection with the present invention is disclosed in co-pending U.S. application Ser. No. 10/189,931 entitled “Method and Apparatus for APC Solver Engine and Heuristic”, such application hereafter incorporated by reference in its entirety.

The solver component 316 enables an operator to validate an APC assisted process (e.g., the APC assisted process meets output specifications over an input specification). The operator can supply the system 300 with a distribution for a plurality of process inputs. Process inputs within the specification range can be systematically generated by the input distribution component 308 and submitted to the solver component 316, which calculates recommended settings that are utilized as seeds to the tool distribution component 310. The tool distribution component 310 can thereafter generate inputs based upon the recommended settings within a defined distribution. Such inputs and settings are received by the canonical model 302 within a particular chamber state to facilitate simulation of a semiconductor manufacturing process. The rendering component 314 can facilitate display of such simulation to the operator, and the operator can review outputs of interest, such as target output values, output specification violations, control setting range violation, etc.

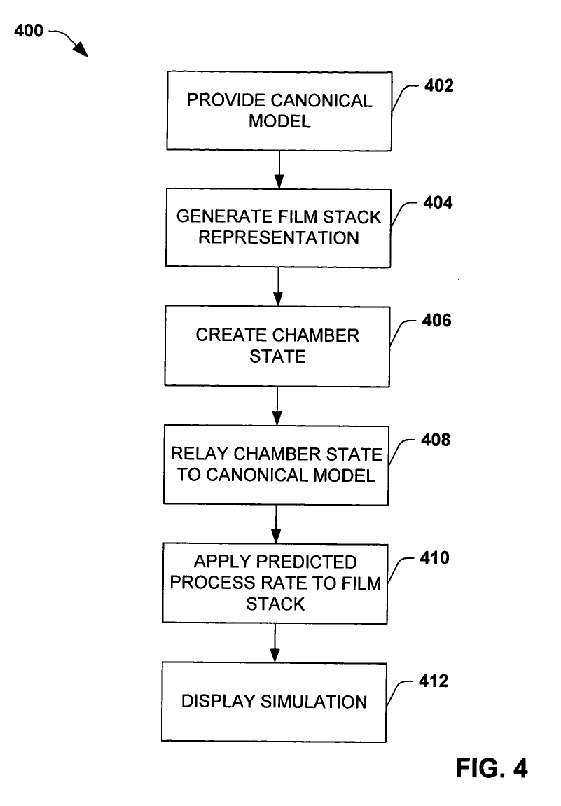

Turning now to FIG. 4, a methodology 400 for validating and verifying an APC assisted system for a semiconductor manufacturing process and/or process step is illustrated. While, for purposes of simplicity of explanation, the methodology is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 402, a canonical model of an APC assisted system is provided, wherein the canonical model facilitates predicting process rate(s) of a particular material given the material, model variable(s), constraint(s), goal function(s), and other constant and non-constant values that can effectuate creating a predictive model. The canonical model can comprise predicted rates for a plurality of materials and a plurality of process steps, and can be created via generating a training set based upon outputs, wherein the outputs were generated with known inputs. Such outputs can be determined utilizing a DOE. The training set can be employed to generate predictive functions describing a process and thereafter divided by time, thus resulting in creation of a predictive model that can predict process rates.

At 404 a film stack representation is generated. For example, the film stack representation can include a plurality of layers, wherein the plurality of layers can include a plurality of blocks. The film stack representation can be generated via a GUI, wherein a library of materials is available for creation of a film stack representation. For instance, an operator can employ click-and-drag techniques to select a material from the library and place such material amongst a plurality of disparate materials, thereby creating a film stack representation. In accordance with one aspect of the present invention, the film stack representation can be defined via a plurality of layers, and the layers themselves can be defined by a plurality of blocks (e.g., several blocks create a layer, and several layers are associated with a film stack).

At 406, one or more simulated chamber state(s) is generated. The chamber state(s) can include all suitable parameters typically associated with semiconductor manufacturing, such as simulation start time, elapsed time between simulated chamber states, material parameters (e.g., identity, height, width, length, . . .), process step identity, flow of chemicals within the process, etc. Material information can be obtained via the film stack representation, and parameters of such film stack representation can be modified based upon process distribution in creating a typical film stack. Furthermore, input variables associated with processing tools such as power, chemical flow, etc., can be varied according to known distribution or distribution obtained empirically via a DOE. Alternatively, a user can enter a desirable distribution into a GUI, thereby enabling customization of a process and verification and/or validation thereof.

At 408, the canonical model receives the chamber state, wherein predicted process rates for a particular process step on an exposed material in the film stack representation are utilized to simulate the process step. The canonical model can predict such process rates given the information included in the chamber state. As the chamber state typically includes elapsed time, the canonical model can accurately predict a process rate.

At 410, the process rate predicted by the canonical model is applied to the film stack, thereby effectuating variation in the film stack according to the process step. For instance, if a process step removes an exposed material in the film stack, the canonical model can predict an amount of material that should be removed over a period of time. At 412, information regarding the predicted process as applied to the film stack representation is displayed to a user. For example, a process step relating to the film stack representation can be displayed to a user in a time frame selected by the user (e.g., the user can choose to view the process step in real-time). Moreover, data can be textually relayed to a user regarding chamber states, various model inputs, constraints, goal functions, or any other suitable data relating to the process step.

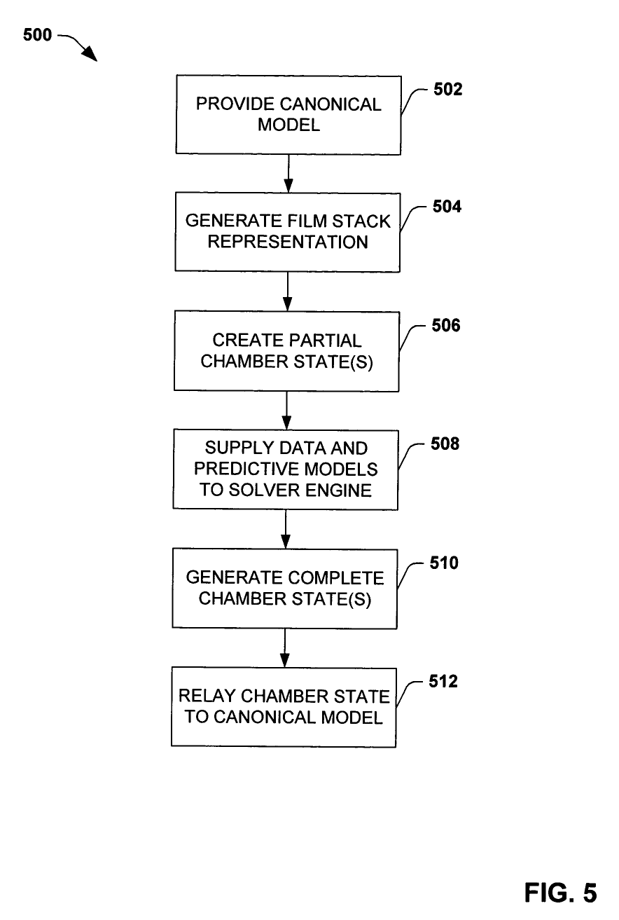

Turning now to FIG. 5, a methodology 500 for verifying and/or validating an APC system based upon a semiconductor manufacturing process simulation is illustrated. At 502, a canonical model is provided that can utilize predictive models to predict a process rate given particular material(s), constraint(s), input(s), goal function(s), and other suitable parameters regarding semiconductor process manufacturing. At 504 a film stack representation is generated, wherein the film stack representation comprises layers of one or more materials, and the layers of materials comprise blocks of specific material and size. At 506, a one or more partial process chamber state(s) is created that includes exposed material(s) in the film stack representation as well as simulated parameters . For example, a partial chamber state can be created, wherein an input distribution system recommends film stack information to be included in the partial chamber state. The partial state includes all parameters except tool controller specific setting parameters. Tool settings require seeds from the solver engine 508. The partial chamber state also comprise process output goal(s), constraint(s), etc.

At 508 input data (e.g., process input tuple(s)) along with applicable predictive model(s) are supplied to a suitable solver engine. The solver engine generates recommendations for recipe control settings based on the predictive model and its associated goals and constraints. At 510 a one or more chamber states is generated. The chamber state can be completed using a suitable tool distribution component. For example, recommended settings from the solver engine component 508 can be used as seeds to the tool distribution component, thereby generating values compatible with an underlying distribution of the device controllers (e.g., flow controller, voltage regulator, etc.) At 512, the canonical model receives the one or more simulated chamber state(s), and simulates a process step based upon parameters of the chamber state and elapsed time between reception of distinct chamber states.

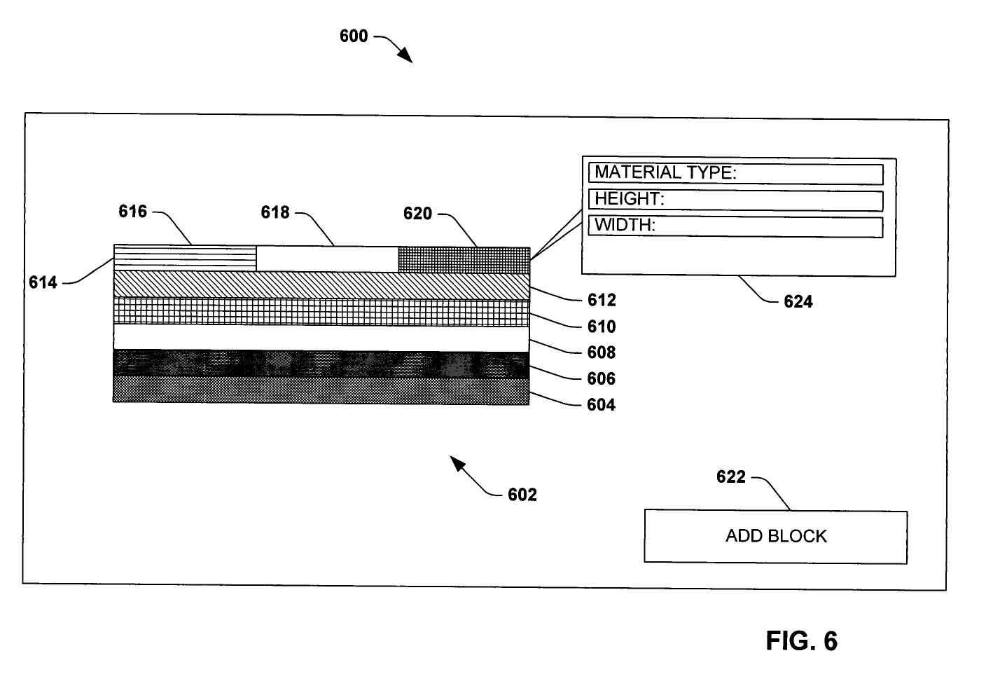

Now regarding FIG. 6, an exemplary GUI 600 that facilitates creation of a film stack representation is illustrated. The GUI includes a graphical rendering of a film stack representation 602, which comprises a plurality of layers 604-614. Layer 614 includes three blocks 616-620 defined by disparate materials utilized in a semiconductor manufacturing process. Moreover, the blocks 616-620 can be of disparate or substantially similar sizes.

An “add block” button 622 can be provided to inform the GUI 600 that a user desirably wishes to add a block to the film stack representation 602. While a button 622 is illustrated for exemplary purposes, it is understood that any manner of informing the GUI that a block is desirably added to the film stack representation 602 by the user is contemplated by the subject invention. For example, keystrokes can be utilized to inform the GUI 600 that a block is desirably added to the film stack representation 602. Upon signifying that a block is desirably added, a text box 624 comprising fields that can be populated by a user can be provided. The fields can include material type, height, width, length, and any other suitable parameter associated with a particular material and process step.

Moreover, a grammar can be provided to facilitate expressing geometry of a film stack and the materials involved. For example, block 616 can be defined as photo resist with height of 300 nm and width of 100 nm, block 618 can be no material (e.g., a gap between materials) with height of 300 nm and width of 50 nm, and block 620 can be BARC with height of 300 nm and width of 100 nm. As blocks 616-620 are defined, layer 614 can be defined within the grammar as follows:
Layer[614]:<Block[616];Block[618];Block[620]>.

Layers 604-612 can likewise be defined in terms of a plurality of blocks, thereby enabling a user to efficiently create an effective film stack representation 602. Thus rather that utilizing the GUI 600 to create the film stack representation 602, the user can utilize the defined grammar to textually create the film stack representation 602.

Moreover, in many instances a chemical process completely removes an exposed layer on a film stack prior to completion of a process step. The subject invention provides guarded process rates to handle such situations as they arise, as a pre-condition can be assigned to each block and/or layer. For instance, if a particular block (Block[1]) is defined as BARC with width of 50 nm and height of 100 nm, and a particular layer (Layer[1 ]) is defined as six consecutive blocks of Block[1], a precondition P₀ can be defined as follows:
P₀:Exposed(Layer[1]) and (Layer[1].Block[*].height=0).

Such a precondition evaluates to true when a current exposed layer is BARC and height of any BARC block is zero. Furthermore, unguarded process rates have an implicit guard (rather than an explicitly defined guard). Such implicit guards ensure that process rates associated with a material are applied when the material is exposed. In instances where more than one guard evaluates to true, the model associated with the first guard (or some other suitable arbitration strategy) can be utilized to simulate the process step.

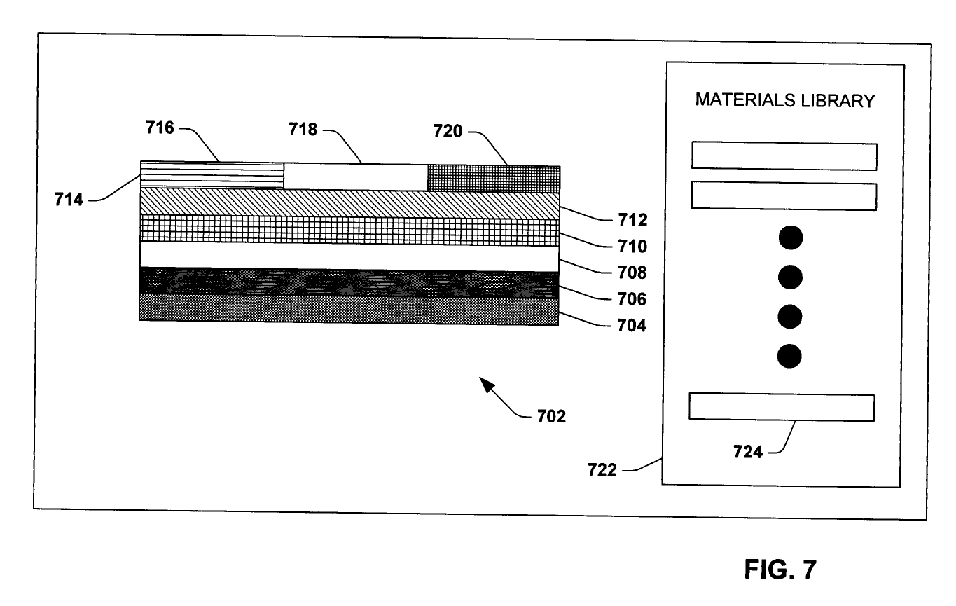

Turning now to FIG. 7, an exemplary GUI 700 facilitating generation of a film stack representation in accordance with another aspect of the present invention is illustrated. The GUI 700 includes a film stack representation 702, and the film stack representation comprises layers 704-714. While the GUI illustrates the film stack representation 702 in two dimensions, it is to be understood that a 3-dimensional film stack and graphical rendering thereof can be created in accordance with an aspect of the present invention. Each of the layers 704-714 can be defined by one or more blocks, which in turn are defined by a material type and size (e.g., height, length, and width). For example, layer 710 can comprise a plurality of blocks of identical material. Layer 714 includes blocks 716, 718, and 720, which are disparate materials of different size.

The GUI 700 further comprises a library 722 of blocks 724 of disparate materials. A user can select a block 724 from the library 722 and place it in a desirable position on the film stack representation 702. In accordance with one aspect of the present invention, the block 724 can be color-coded according to a particular material to facilitate distinguishing materials in the film stack representation 702. The blocks 724 can be selected and positioned via mouse, touch screen, keystrokes, voice commands, or other similar selection methods and positioning methods. Moreover, the blocks can be desirably sized utilizing a click-and-drag method or other similar method for sizing computer objects. Alternatively, upon selecting the block 724 defined by a particular material from the library 722, fields that can be populated by a user can be provided to facilitate desirably sizing the block 724.

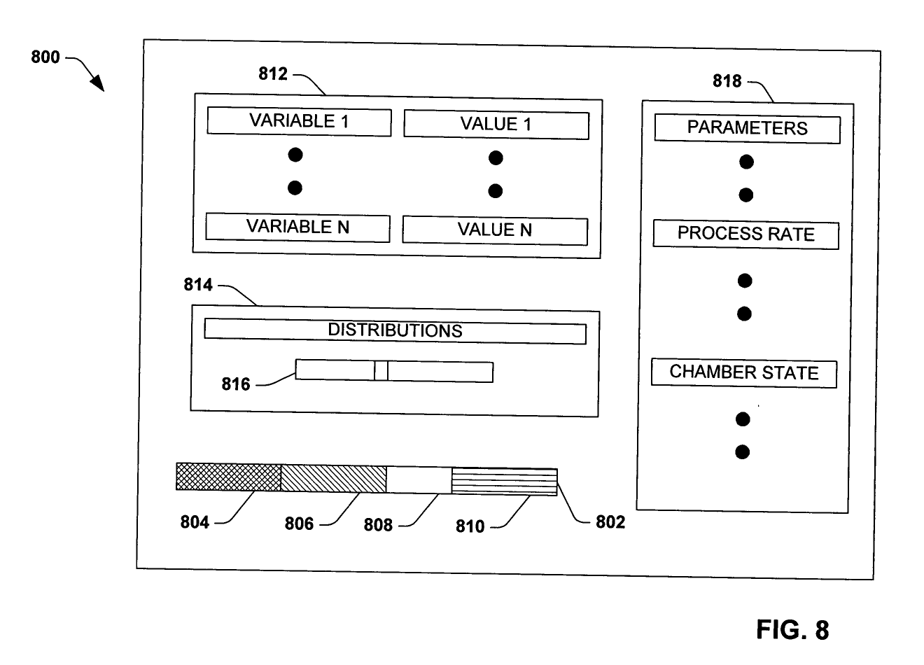

Now regarding FIG. 8, an exemplary display 800 that shows various simulation parameters and information is illustrated. The display 800 includes a graphical representation of a layer 802 comprising blocks 804-810 during a simulated process step on the layer 802. The layer 802 can graphically vary according to predicted process rates, thereby enabling a user to visualize a process without requiring actual use of test wafers and/or actual wafers. Furthermore, simulation speed can be varied, and the simulation can be halted at request of a user (e.g., a user can desirably halt simulation after completion of a process step). The display 800 further includes a section 812 that illustrates output values associated with given variables. The section 812 can display vector(s) of input variables and settings as well as associated output vector(s) either textually or graphically. Moreover, a graphical rendering can be in two or three dimensions.

A distribution variation section 814 can also be provided in accordance with an aspect of the present invention. The distribution variation section 814 can include a plurality of editable fields, wherein a user can enter a desirable distribution for a corresponding variable. Furthermore, a slider 816 can be provided to enable a user to define distribution of a plurality of input variables and tool control parameters. A section 818 that can display current parameters, process rates, and chamber states can also be provided within the display 800 along with any other information regarding a semiconductor manufacturing process desirably viewed by a user. Enabling the user to alter process inputs and control settings (e.g., distributions for process tools, input values, . . .) provides a simulation of impact of inputs and setting variation on process output desirable by the user. The user can therefore explore and analyze a complete process window of an APC assisted process.

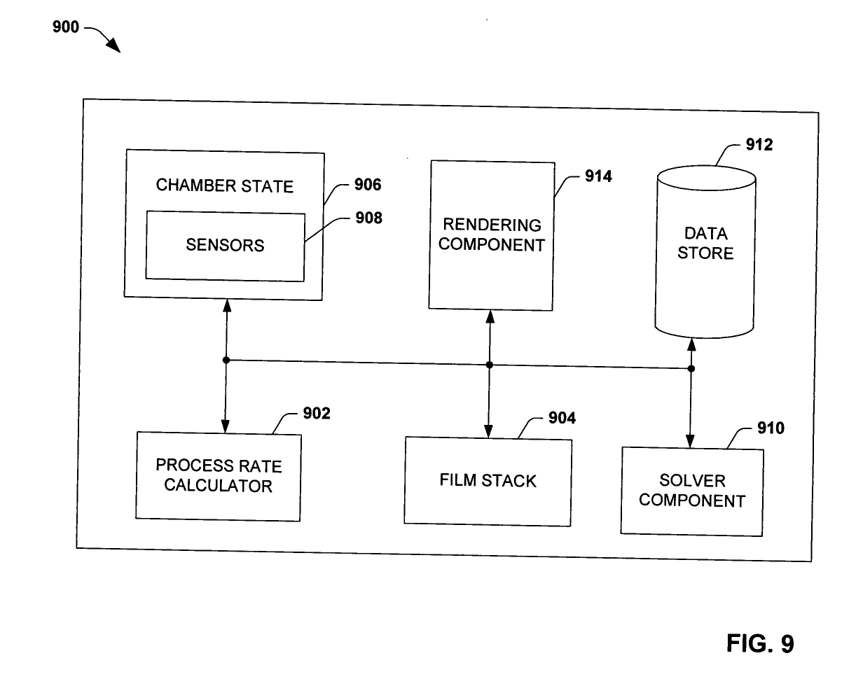

Turning now to FIG. 9, a system 900 that facilitates in situ monitoring of a semiconductor manufacturing process in accordance with one aspect of the present invention is illustrated. The system 900 includes a process rate calculator 902 that can determine process rates regarding a particular material given various inputs and settings. A film stack 904 is provided, wherein the semiconductor manufacturing process occurs on the film stack 904. The film stack 904 can be provided with sensors, thereby enabling a determination of material type and film stack state. A chamber state component 906 can relay present parameters of the semiconductor manufacturing process to the process rate calculator 902 via sensors 908. The process parameters can be captured at predetermined time intervals utilizing SECS/GEM, HSMS, or other suitable mechanisms to collect data monitored by the sensors 908. The solver component 910 can monitor the present chamber state and process rate to determine desirable control inputs for process tools. The process tools can adjust according to optimal input values calculated by the solving component 910. All process-related data can be relayed to a data store 912 for later analysis. A rendering component 914 facilitates real-time display of the semiconductor manufacturing process. In situ monitoring can occur due to similarity in data format (e.g., chamber states and process rates) compared to data utilized in a simulation.

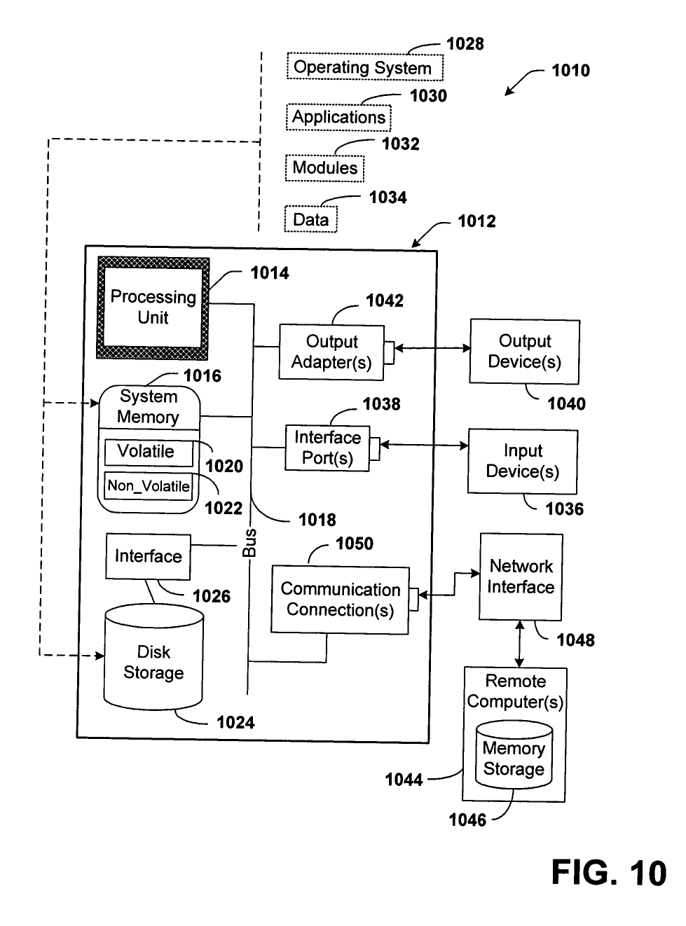

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be understood that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, sound card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, a universal serial bus (USB), and a 1394 bus. Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 1202.3, Token Ring/IEEE 1202.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

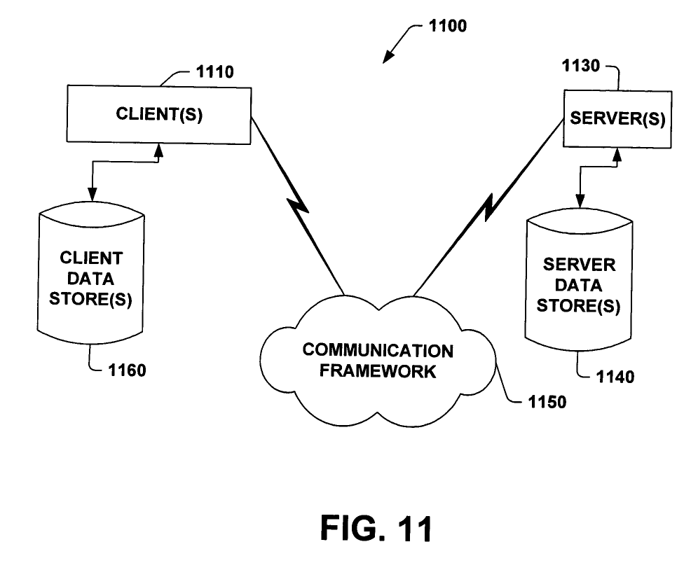

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates verifying and/or validating an APC assisted process via simulation, comprising:
a film stack representation; and
a canonical model that predicts process rates, the process rates predicted based at least in part upon an exposed material in the film stack representation.

2. The system of claim 1, the film stack representation comprising at least one layer.

3. The system of claim 2, the layer comprising at least one block, the at least one block defined by material type and size.

4. The system of claim 3, the film stack representation generated via associating blocks within a graphical user interface.

5. The system of claim 3, the film stack representation generated via associating blocks utilizing a defined grammar.

6. The system of claim 3, the material type and size being user-defined.

7. The system of claim 1, the film stack representation comprising at least one guarded process rate; the at least one process rate being associated with one or more blocks.

8. The system of claim 7, a precondition utilized as a guard for a predictive model based process rate.

9. The system of claim 1, the canonical model receiving a chamber state and predicting a process rate based at least in part upon parameters of the chamber state, the parameters including at least one of elapsed simulation time, process tool settings, exposed material, and semiconductor device characteristics.

10. The system of claim 9, one of the process tool settings being generated according to a distribution.

11. The system of claim 10, the distribution being user-defined.

12. The system of claim 10, the distribution obtained via a design of experiments.

13. The system of claim 9, device characteristic inputs being generated according to a distribution.

14. The system of claim 13, the distribution being user-defined.

15. The system of claim 13, the distribution obtained via a design of experiments.

16. The system of claim 1, further comprising a solver for generating recipe parameter recommendations according to at least one of inputs, outputs, goal(s) and constraint(s) of the canonical model.

17. The system of claim 16, a parameter recommended by the solver varied according to a distribution.

18. The system of claim 17, the distribution being user-defined.

19. The system of claim 17, the distribution obtained via a design of experiments.

20. The system of claim 17, the parameter generated by a pseudorandom variate generator.

21. The system of claim 1, further comprising a rendering component that facilitates display of the film stack representation as a process is simulated.

22. The system of claim 21, the rendering component facilitating display of at least one of inputs to the canonical model, outputs of the canonical model, parameters of a process chamber, simulation start time, elapsed simulation time, the film stack representation, and distribution of the inputs.

23. The system of claim 1, the canonical model comprising one or more of model variables, model constraints, and model goals.

24. The system of claim 23, the canonical model contemplating one of the model constraints and the model goals.

25. The system of claim 24, the canonical model predicting process rates in two dimensions.

26. The system of claim 24, the canonical model predicting process rates in three dimensions.

27. The system of claim 1, wherein a simulation speed can be customized by a user.

28. The system of claim 1, wherein a simulation can be halted by one of a user and a predefined interrupt.

29. The system of claim 1 comprised by a computer-readable storage medium.

30. A method for validating a semiconductor manufacturing process, comprising:
generating a film stack representation; and
providing a canonical model that predicts process rates for an exposed material in the film stack representation given a process step.

31. The method of claim 30, further comprising:
creating a chamber state, the chamber state comprising parameters associated with a process chamber; and
relaying the chamber state to the canonical model.

32. The method of claim 31, further comprising displaying the film stack representation as a process is simulated.

33. The method of claim 31, further comprising displaying chamber state parameters and associated outputs from the canonical model.

34. The method of claim 31, further comprising determining appropriate chamber parameters given current chamber parameters and a predicted process rate.

35. The method of claim 34, the determined chamber parameters varied according to a distribution.

36. The method of claim 35, the distribution being user-defined.

37. The method of claim 35, the distribution obtained via a design of experiments.

38. A system that facilitates verification of an APC assisted process comprising:
means for generating a film stack representation;
means for obtaining parameters relating to a process chamber at a particular point in time; and
means for predicting a process rate based at least in part upon the film stack representation and the parameters.

39. The system of claim 38, further comprising means for selecting a simulation time.

40. The system of claim 39, further comprising means for displaying a simulation of the predicted process as applied to the film stack representation.

41. A data packet that passes between at least two computer processes, comprising:
a canonical model that predicts process rates based at least in part upon parameters of a tool chamber, an exposed material, and a particular process step; and
a film stack representation that comprises a layer, the layer including a material utilized by the canonical model to predict a process rate.

42. A system that facilitates in situ monitoring of a semiconductor manufacturing process, comprising:
a process rate calculator that can calculate semiconductor manufacturing process rates based at least in part upon sensed parameters of a process chamber tool and time between receiving sensed parameters;
a film stack comprising a material;
a solver component that generates desirable parameters of the process chamber tool based at least in part upon the calculated process rate and the sensed parameters; and
a rendering component that displays the film stack as the film stack is processed.
